(19) United States
(12) Patent Application Publication
(10) Pub. No.: US 2004/0053759 A1
(43) Pub. Date: Mar. 18, 2004

(54) Packaging

(76) Inventors: Michael Clements Markham, Auckland (NZ); Craig Leslie Porteous, Auckland (NZ)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/398,752

(22) PCT Filed: Oct. 11, 2001
(86) PCT No.: PCT/NZ01/00223

(30) Foreign Application Priority Data
Oct. 11, 2000 (NZ) 507414

(51) Int. Cl. B31B 1/86

(52) U.S. Cl. 493/226

(57) ABSTRACT

This invention relates to a method of forming a bag. The method includes the step of forming a line of weakness in a portion of material being used to form a part of the bag, placing a patch over the line of weakness, and forming the bag. The arrangement and construction is preferably such that the patch is located substantially inside the bag thus formed. The line of weakness and patch may preferably act as a self-closing opening for the bag. A bag which includes such a self-closing opening, and bag machinery used for forming such a bag, are also described.

### TECHNICAL FIELD

This invention relates to improvements in or relating to packaging. In particular, but not exclusively, the invention relates to improvements in or relating to valve bags, that is bags which are fabricated as a closed bag, but which are provided with a self-closing opening. It is to be understood and appreciated however that the invention may have applications other than just to valve bags, and hence the prior art and possible applications of the invention as discussed below are therefore given by way of example only.

### BACKGROUND ART

The term “valve bag” is commonly used to describe a bag which is fabricated as a closed bag, but which is provided with a self-closing opening.

Presently available valve bags are generally fabricated as a bag, with both top and bottom seals, and with a self-closing opening through which a spout or horn is inserted to fill the bag, usually with a granular or powdered material. Self-closing may be accomplished by the use of a flap of material which overlaps the filling opening, but which is forced away from the bag-proper or opening during filling. The arrangement and construction of such bags may be whereby the valve opening, comprising the flap, is pressed closed by the contents of the bag when the filling spout is removed from the valve opening. This may be accomplished, for example, by placing the filled bag on its side and/or upsidedown so that the contents of the bag force the valve opening closed.

The use of such a self-closing opening or valve in valve bags eliminates the need for a closing and/or sealing operation after filling. This is especially important in industries where the material with which the bag is being filled would contaminate the seal when the bag is ordinarily sealed/closed.

Other presently available valve bags are usually made of either paper or a plastics material, with the valve being fixed or folded into a top end and/or side of the bag.

Such valve bags are usually constructed of multiple webs, or of single webs folded in a complex manner, in order to be able to accommodate the self-closing valve. Production means used to produce such bags are complex, expensive, and are usually only able to be used for this single purpose.

An example of machinery which produces such a prior art valve bag is the Valve Bottomer AD Plastic SL/LF machine produced by Windmoller & Holscher of Germany.

It is an object of the present invention to address the foregoing problems or at least to provide the public with a useful choice.

Further aspects and advantages of the present invention will become apparent from the ensuing description that is given by way of example only.

### DISCLOSURE OF INVENTION

According to one aspect of the present invention there is provided a method of forming a bag, said method including the steps of:

(a) forming a line of weakness in a portion of material being used to form a part of the bag,

(b) placing a patch over said line of weakness,

(c) forming the bag,

the arrangement and construction being such that said patch is located substantially inside the bag thus formed.

According to another aspect of the present invention there is provided a method of forming a bag, substantially as described above, wherein said line of weakness is formed as a perforation.

According to an alternative aspect of the present invention there is provided a method of forming a bag, substantially as described above, wherein said line of weakness is formed as a slit.

According to another aspect of the present invention there is provided a method of forming a bag, substantially as described above, wherein there is provided at least one self-closing opening in the bag thus formed.

According to another aspect of the present invention there is provided a method of forming a bag, substantially as described above, wherein said patch is stitched to the portion of material forming said part of the bag.

According to an alternative aspect of the present invention there is provided a method of forming a bag, substantially as described above, wherein said patch is heat sealed to the portion of material forming said part of the bag.

According to a further aspect of the present invention there is provided a method of forming a bag, substantially as described above, wherein said at least one self-closing opening is formed within or comprises part of a gusset which is also formed during said method.

According to a further aspect of the present invention there is provided a method of forming a bag, substantially as described above, wherein said method includes a further step which allows for the bag, thus formed, to include carrying means such as a handle.

According to a further aspect of the present invention there is provided a method of forming a bag, substantially as described above, wherein said handle is formed by cutting, and/or punching, and/or heating a section of the bag either during the bag forming step(s), or after the bag has been formed, to form an aperture which may act as the handle.

According to a further aspect of the present invention there is provided a method of forming a bag, substantially as described, wherein said method includes a step which allows for the formation of closure means, said closure means being adapted or able to close and/or seal said at least one self-closing opening as or when required or desired.

According to a further aspect of the present invention there is provided a method of forming a bag, substantially as described, wherein said closure means is formed by attaching a closure flap to the outside of the bag thus formed, and adjacent to the self-closing opening.

According to a further aspect of the present invention there is provided a method of forming a bag, substantially as described, wherein said closure flap is provided with sealing means to enable it to be sealed over said self-closing opening.

According to a further aspect of the present invention there is provided a method of forming a bag, substantially as described, wherein said sealing means is adapted or allows for the releasable sealing of said closure flap over said self-closing opening.

According to another aspect of the present invention there is provided a bag, said bag including a self-closing opening, and said bag being formed from any of the methods, substantially as described above.

According to a further aspect of the present invention there is provided bag forming machinery to produce a bag with a self-closing opening, substantially as described above.

The method of forming the bag may preferably include the steps of forming a line of weakness in a portion of the material which is being used to form a part of the bag, placing a patch over the line of weakness, and then forming the bag. The arrangement and construction may preferably be such that the patch may be located substantially inside the bag, once the bag has been formed.

Any suitable line of weakness may be utilised as required or as desired, or as dictated by the proposed use of the bag.

For example, the line of weakness may be in the form of a perforation cut or punched into or otherwise formed in the portion of material being used to form a part of the bag. In such an embodiment the perforation may be broken when or as required by a user of the bag to create an opening.

Alternatively, and especially in an embodiment where the material forming a part of the bag is a plastics materials, the line of weakness may be formed by the application of heat to produce a thinner and/or weaker line on or along a surface of the material being used to form a part of the bag. The thin and/or weak line of material may therefore be broken by a user of the bag, when or as required, in order to create the opening.

In a preferred embodiment, the line of weakness may be in the form of slit cut into or formed within the material being used to form a part of the bag.

The patch which may be placed over the line of weakness may be made of any suitable material as appropriate, or as dictated by the proposed use of the bag. Preferably the patch may be comprised of substantially the same material as that which is comprising the substantial part of the bag, although a different material maybe utilised if required or desired.

Any suitable or known means may be utilised for affixing the patch over or about the line of weakness and/or to the portion of material being used to form a part of the bag. For example, the patch may be stitched, heat sealed, affixed by the use of hot melt adhesive or glue, affixed by the use of ultra-sonic welding techniques/apparatus, or a combination of these or any other known methods.

After the patch has been placed over the line of weakness the bag may be formed using standard and known bag forming machinery and/or technology which will be well known to the skilled addressee or someone skilled in the art.

Preferably the bag forming step may be such that the patch is located substantially inside the bag thus formed.

It may be appreciated that the patch, once fixed to the material which comprises the substantial part of the bag, combined with the line of weakness, provides a self-closing opening or valve into the bag thus formed.

If the patch is heat sealed to the material being used to form a substantial part of the bag, the arrangement may preferably be such that the patch is sealed to provide at least one opening between the patch and the line of weakness, which ultimately may form part or all of a self-closing opening into the bag, once formed. Preferably the patch may be sealed along three sides to thus leave one side open to provide for the self-closing opening.

The self-closing opening may be formed on or in any portion or any location on the bag thus formed.

For example, the self-closing opening may be formed in or towards a comer of the bag thus formed. Alternatively, the self-closing opening may be formed in either the front or rear face of the bag thus formed, and preferably towards an upper end thereof.

Alternatively, and/or additionally, if the bag is one which is formed with side-gussets, the self-closing opening may be located within the folds of such a side gusset.

It is also envisaged that there may be more than one self-closing opening, substantially as described above, formed within any one bag. Such flexibility in location, orientation, and the number of self-closing openings that may be formed in a bag, allow for many variations of valve bags to be produced and which may be utilised as required or as desired or as dictated by the proposed use of the bag, and/or the type of material that the bag is destined to contain.

The positioning of the slit and/or patch and/or self-closing opening may be determined by several requirements, for example the bag size, the print width and repeat length, the type of material which is to be placed within the bag and/or a users' requirements.

The line of weakness may also be formed and/or orientated such that the self-closing opening formed in the formed bag is either parallel to the web direction or perpendicular to the web direction of the material forming the bag.

In one embodiment, the bag thus formed may include carrying means such as a handle. The handle may allow for ease of carrying the bag when full or empty. Any suitable carrying means may be formed or attached to the bag as required or as desired, or as dictated by the proposed use of the bag.

For example, the handle may be in the form of an aperture cut into or through the bag. Such a handle could be formed by simply cutting and/or punching and/or heating a section of the bag to remove material from it, thus leaving an aperture which may be utilised as a handle. Preferably such an aperture would be formed in or towards the top portion of the bag, and above the self-closing opening so that the self-closing opening will remain closed when or as the bag is being carried.

It is envisaged that the material, such as plastics material, adjacent or surrounding the handle may be multi-layered or provided with strengthening ribs to provide additional strength to allow for the bag to be carried, especially when full.

There are many other known methods and apparatus utilised for producing handles in bags, particularly plastic bags, and such methods and apparatus would be known to the skilled addressee or person skilled in the art and need not be further described herein.

Furthermore, the bag, thus formed, may be provided with closure means to allow for the closure of the self-closing opening when or as required or desired, for example when the bag is sufficiently full. It is envisaged that the closure means may be particularly suitable for bags destined to contain undesirable components such as medical waste because the closure means will restrict exposure to bacteria, insects etc, and may also reduce associated smells.

Any suitable closure means may be utilised as required or as desired. For example, the closure means may be in the form of a closure flap attached to the bag adjacent the self-closing opening. The flap may be lifted in order to place the contents within the bag, and may be provided with an adhesive strip, preferably with a removable cover, which when removed will allow the flap to be sealed over the self-closing opening. The adhesive strip may be of a form to allow for the flap to be resealable with respect to the opening and/or bag, alternatively it may be designed to deform the bag and/or the self-closing opening once opened. Such adhesive strips are well known and would be familiar to the skilled addressee and hence need not be further described herein.

Such a flap may be formed during the bag forming process or, and preferably, may be attached (for example by the use of adhesive, heat sealing, ultra sonic sealing etc) to the bag once formed.

It is envisaged that the addition of closure means may be particularly suitable for bags where the self-closing opening is formed on either the front or the rear face of the bag.

The material comprising the bag may preferably be a plastics material. Any suitable material may be utilised, for example may be co-extruded, blown film, cast film, or mono-layer blown film using a variety of plastic polyethylene resins or starch based resins, and which could also have masterbatches, additives or colourants in the formulation.

Preferably, the bag may be formed on known bag converting machines substantially as discussed below. Moreover, the bag could also be fabricated manually, using known methods/apparatus, if required.

Plastic film in sheet form may be unwound from an unwind unit on the bag machine. The film web may move through a web stopper where the film may be momentarily stopped. While the film is stopped a slitter unit may punch a slit (or perforation) in the web. The position of this slit may be synchronised to a patch applicator, which may place a patch over the next slit in line. This patch may be heat sealed or glued to the outer web. The positioning of these two operations may be determined by the location of the valve on the completed bag.

An alternative method for making the slit/perforation and applying the patch could be:

A rotary slitter and patch applicator could be used. Under this method of fabrication the web stopper would not be used and the slit/perforation and patch would be applied to the moving web. This method would increase production speeds. After the patch has been applied the web may move through a V former unit which may fold the web. After folding, the web may pass through an edge sealing unit and across a chilled roller unit. This operation seals the folded web to form a tube. This seal is commonly referred to as a fin seal.

An alternative sealing method known as a lap seal can also be used. Under this sealing method, both webs pass through a sealer unit comprising three floating seal heads in a series, followed by a water-cooled seal cooling shoe. The sealer unit forms a seal (to the outer web) to join the overlapped edges of the web or film to form a tube.

If a side-gusseted bag is required, the web (now in tubular form) may pass through a post-gusseting unit, where side gussets are formed in the tube. If side gussets are not required the web (now in tubular form) will by-pass this unit.

The web (in tubular form) may now enter the sealing unit of the machine. If required, the handle may be formed in the bag at this stage, substantially as described previously. Seals may then be made at the top and bottom of the bag, which may then be cut to length. The completed bag may now move to an indexing table where it may be inspected and packed.

It is envisaged that a bag, formed substantially from the above methods and apparatus, may be particularly useful as a valve bag, as described previously. That is, the self-closing opening in the bag thus formed may be utilised to allow for the filling of the bag. Furthermore, the self-closing opening may be automatically pressed closed by the contents of the bag once filled, (and once the filling spout, horn or other filling apparatus has been removed from the opening).

It is envisaged that the bag may have a variety of uses or applications, particularly in relation to granular or powdered material. However, it is to be understood and appreciated that the use of the bag is not to be limited to such products.

### BRIEF DESCRIPTION OF DRAWINGS

Further aspects of the present invention will become apparent from the following description which is given by way of example only and with reference to the accompanying drawings in which:

FIG. 1 is a schematic side view of apparatus for producing a bag, being one possible embodiment of such apparatus for use in or with the present invention;

FIG. 2 is a schematic view showing a slit and patch being formed on a film web; and

FIG. 3 is a view of a bag thus formed, being one possible embodiment of a bag with respect to the present invention; and

FIG. 4 is a perspective view of another possible embodiment of a bag thus formed; and

FIG. 5 is a side view of the bag depicted in FIG. 4.

### BEST MODES FOR CARRYING OUT THE INVENTION

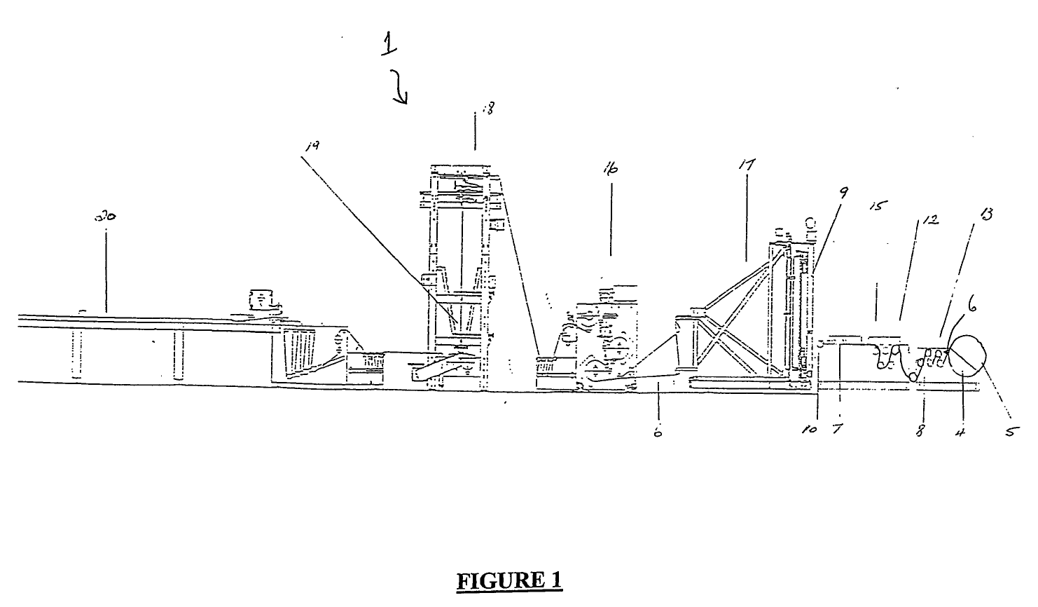

Having regard to FIG. 1, there is shown apparatus for forming a bag, the apparatus being generally indicated by arrow 1.

The apparatus 1 includes a hydraulic loading powered unwind 4 which is fitted with a roll 5 of sheet type plastic film 6.

The film 6 is placed on the unwind 4 such that when it is unwound the inside of the bag to be formed will be facing up on the web stopper 7 located downstream in the process/apparatus 1.

There is provided an edge guided roll dancer 8 which controls unwind speed and film tension. The film 6 is edge-guided by steering roll system 9 to maintain correct lateral positioning through the downstream machinery.

The film passes into the web stopper 7 which is a known machine manufactured by Amplas Inc, of Green Bay, Wis., USA. The web stopper 7 converts the continuous web motion into intermittent web motion for the purpose of performing operations which require the web to be stopped, momentarily, before converting the web motion back to continuous.

Draw rolls 10 intermittently advance and stop the web 6 at predetermined distanced intervals to cut a slit (not shown in FIG. 1) into the web 6. The slit is the line of weakness referred to earlier in this specification. The draw rolls 10 also stop the web 6at predetermined distance intervals in order to apply a patch over the slit, in the manner substantially as described earlier in the specification.

The draw rolls 10 are driven by a servo motor (not shown) in a time sequence of approximately 50% motion time and 50% rest time. There is also provided a photo scanner 12 to provide a signal to the servo motor in order to keep a printed web in registration with the operation to be performed on it.

There is provided a dancer 13, which is an accumulating system which, when the draw rolls 10 are stopped, accumulates web on the upstream end and pays out on the downstream end. When the draw rolls 10 advance the web, the procedure reverses. The dancer 13 is adapted to operate at an equilibrium point when the process is in continuous operation.

During the stopped portion of the cycle the web 6 is punched with a blade operated by an air cylinder (or servo motor or any other actuating means) to produce a straight continuous slit approximately 150 mm long either in the web direction or transverse to the web direction as required or as desired to create the opening for what will become the self-closing opening or valve in the bag. After the valve opening or slit is cut, the web 6 advances one repeat length during the next cycle and stops under the patch applicator 15. The patch (or label applicator as it is sometimes referred to) then places the patch (not shown) on the top of the web 6. The patch applicator 15 is a commercially available unit sold by Macro Engineering of Oakville Ontario, Canada or by Park Air of Brocton, Mass., USA. The patch is rectangular and is applied to the web 6 on the inside surface of the bag to be subsequently formed, and in the proper position to complete either a web direction valve opening or a transverse direction valve opening. The patch is attached to the bag material at three edges with either a heat seal or with an adhesive which is usually pre-applied to the patch. After application of the patch, the intermittent motion of the film in the web stopper 7 is converted to continuous film motion by the dancer/accumulator 13.

After the patch has been applied to the web 6, it moves through a V former unit 17 which folds the web.

After folding, the web 6 with the patch attached on its inside now passes through an edge sealing unit 16 and across a chilled roller unit. The edge sealing unit seals the two edges of the web 6 to form a continuous tube.

An alternative sealing method known as a lap sealer (which is well known within the industry) can also be used under this method. The web 6 with the patch attached on its inside feeds into the lap sealer (not shown). This machine, which is commonly known in the bag industry as Amplas Model #MLS-60, folds the bag into a “C” shape with a slight overlap in the centre of the bag. A sealer (not shown) made up of three floating seal heads in a series followed by a water cooled seal cooling shoe, forms a seal to join the overlapped edges of the web or film to form a tube.

Production of such a bag, using the edge sealing method of manufacture, requires more complex machinery, but that bag has the advantages of having a better graphics display capability and allows the bag to be constructed of multi layers of materials which are non-sealable to each other because the inside layer is sealed to the inside layer rather than inside to outside as with the lap sealer.

The continuous tube then feeds into a conventional post gusseter 18 known as Amplas Model #6203-60 which is equipped with an internal mandrel within the tubular web to guide it in the gusset process rather than inflating the tubular web with air as is done in the usual gusseting process. The mandrel 19 is used because the web with the valve slits in it may not hold the air and a partially collapsed tubular web would be susceptible to wrinkling and poor folding tolerances. The gusseted web with the patch on the inside surface then passes to the bag machine 20.

A second method of producing an adhesive patch type valve bag is by eliminating the web stopper 7 and the heat seal patch attachment stop and replacing them with a continuous web patch applicator and a valve opening slitter that will cut the openings on a continuously moving web. A frame may be utilised which contains rollers that guide the web past the valve opening slitter and patch applicator. Continuous web adhesive patch or label applicators are sold by Quadrel Label Systems, USA.

In such an embodiment, the valve opening slitter may be used to make a slit that is parallel to web direction, and may consist of a blade that engages the moving web which is supported by film supports, and remains engaged with the web for a time or distance duration as determined by a programmable logic controller that may or may not be part of the bag machine servo controller. It can be actuated by an air cylinder, servo motor or other means.

If the valve opening is to be transverse to the web direction, the slitter blade can be activated by a servo actuated diagonal travel knife system or other commercially available knife system. The knife system may consist of knife actuating means and support means and may be actuated by a diagonally mounted ball screw driven by a servo motor. A programmable logic controller (not shown) may receive one input signal from an encoder or other means which is proportional to web motion. If the web is printed, the signal is combined with a signal from a photo scanner 12. The combination of signals, together with a proper program to control the knife system motion and knife actuation timing, will cause the knife to engage the web at the proper position with respect to the eye mark and at the proper speed with respect to web speed to produce a slit that is perpendicular-to web motion and is in the proper position on the web. It is apparent that the knife system must only travel for the distance to make the correct length cut and will return to a preprogrammed home position after a list is made in anticipation of the next cut cycle.

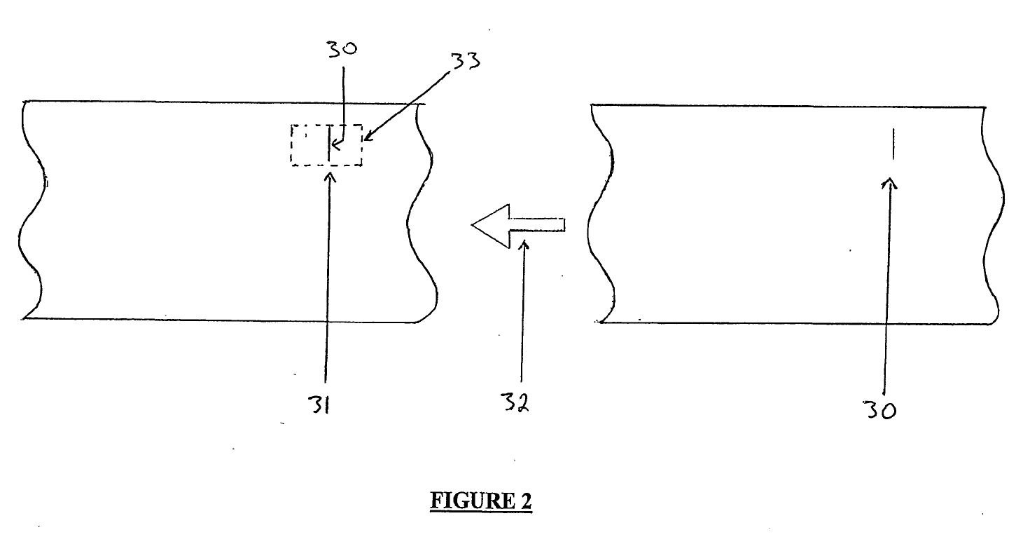

Having regard to FIG. 2, there is shown a schematic view of the web 6 during the time when the slit 30 and patch 31 are formed therein and thereon respectively.

As can be seen from FIG. 2, the slit 30 is formed transversely across the web 6 and perpendicular to the direction the web 6 is travelling, the direction being indicated by arrow 32.

After the slit 30 has been formed, the patch 31 is placed thereover and sealed around three sides. The one side 33 is left unsealed thus forming the self-closing opening into the bag (once formed).

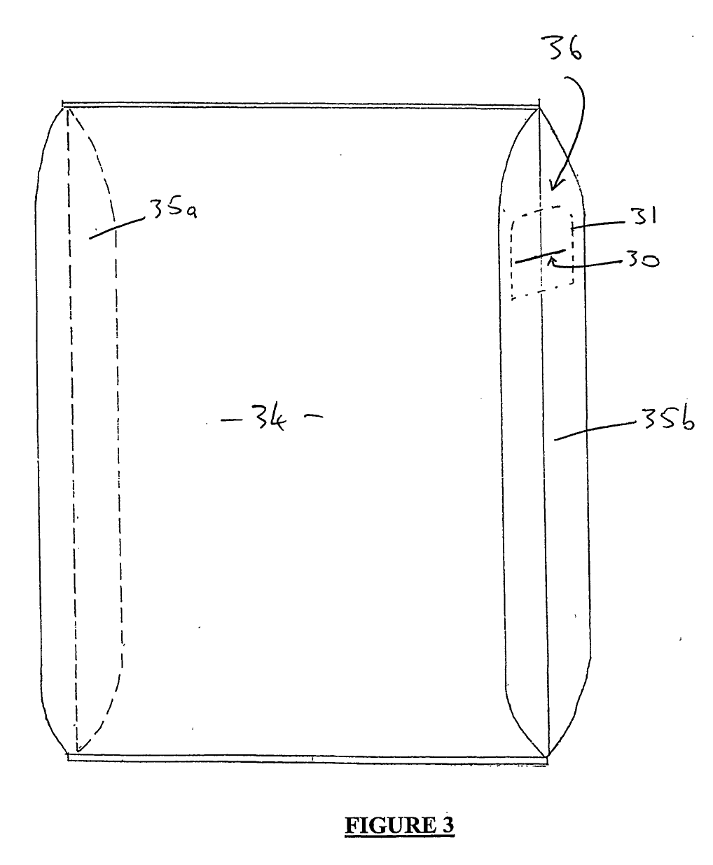

The positioning of the slit 30 and patch 31 in the embodiment shown in FIG. 2 ultimately produces a bag with the self-closing opening formed in a side gusset. An example of such a bag is illustrated in FIG. 3.

Having regard to FIG. 3 there is shown a formed bag 34 with side gussets 35a,b. As can be seen, the self-closing opening, generally indicated by arrow 36, is formed in the side gussets 35a,b. The self-closing opening 36 comprises the slit 30 and patch 31 formed during the process as previously described.

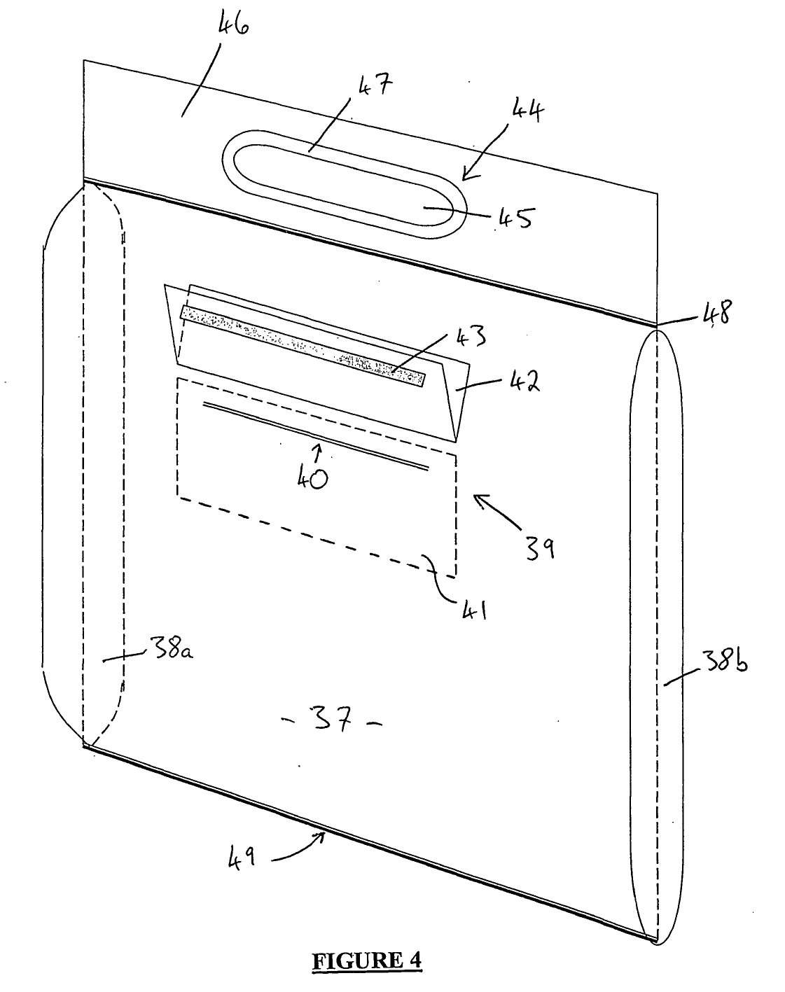

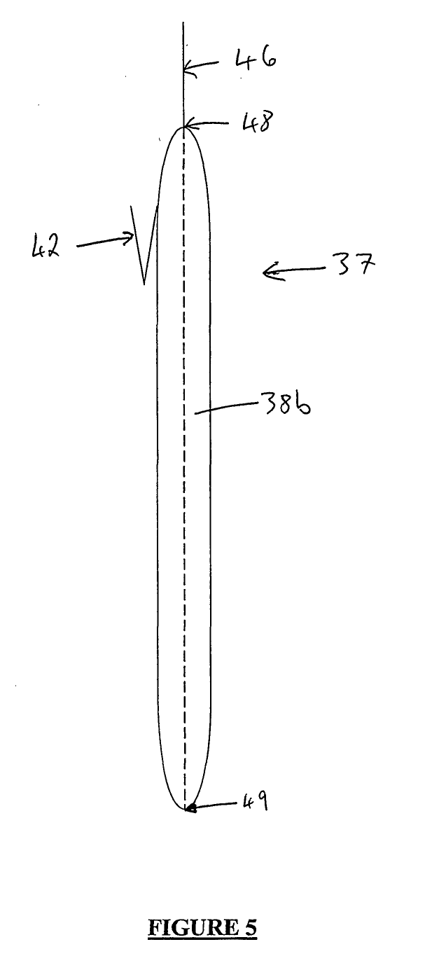

FIGS. 4 and 5 illustrate a further embodiment of a bag which may be formed by the bag forming methods and apparatus.

FIGS. 4 and 5 illustrate a bag 37 which is also provided with side gussets 38a,b. The bag 37 is provided with a self-closing opening, generally indicated by arrow 39, comprising a slit 40 and a patch 41.

The self-closing opening 39 is positioned on the front upper face of the bag 37.

The bag 37 is also provided with closure means in the form of a closure flap 42. The closure flap 42 comprises a piece of plastics material which is glued to the front face of the bag 37 and bent back on itself as shown. The closure flap 42 is provided with a removable strip 43 which covers an adhesive strip.

In use, the closure flap 42 may be bent upwards as shown, thus rendering the self-closing opening accessible, for example for filling purposes. Alternatively, the closure flap 42 could be bent down thus covering the self-closing opening 39 so that the flap 42 would need to be lifted each time an item is to be placed into the bag 37 through the opening 39. Such an arrangement may be particularly suitable should the bag 37 be used for storing undesirable items such as medical waste and the like. That is, the fact that the flap 42 would hang down over the self-closing opening 39 after each item had been placed therein would minimise exposure to bacteria, insects and the like, and may also reduce any associated smells.

The self-closing opening 39 may be sealed as or when required or desired by peeling off the strip of material 43 and closing the flap 42 down over the self-closing opening 39 to thus seal same.

The bag 37 is also provided with a handle generally indicated by arrow 44. The handle consists of an aperture 45 which is surrounded by strengthening material 47. The aperture 45 is punched out of the material 46 prior to the seals 48, 49 being made at the top and bottom of the bag 37.

We believe that the advantages associated with the apparatus and methods described herein include, but are not limited to, the following:

1. The bags thus formed are constructed of a single web and patch which does not have to be folded in a complex manner in order to accommodate the self-closing opening.

2. The production means and apparatus to produce the bags are relatively non-complex, in-expensive, and may be able to be used for standard bag forming techniques as well as for forming the self-closing openings. That is, the apparatus is not specialised and is not limited to just forming a bag with a self-closing opening.

3. The self-closing opening can be orientated such that the slit opening is either parallel to the web direction or perpendicular to the web direction.

4. The self-closing opening can be placed in numerous locations on a bag as required or as desired. Such flexibility in location and orientation will allow many variations of valve bags, which allow their placement in niche markets.

5. Because the simplicity and low cost of the patch attachments, and the non-dedicated machinery, the machinery can be more versatile.

6. The design of the valve bag enables a valve bag with a handle to be manufactured, substantially as described previously.

7. The design of the valve bag enables a closure means to be included, substantially as described previously.

Aspects of the present invention have been described by way of example only and it should be appreciated that modifications and additions may be made thereto without departing from the scope thereof as defined in the appended claims.

The claims defining the invention are:

1. A method of forming a bag, said method including the steps of:
(a) forming a line of weakness in a portion of material being used to form a part of the bag,
(b) placing a patch over said line of weakness,
(c) forming the bag,
the arrangement and construction being such that said patch is located substantially inside the bag thus formed.

2. A method of forming a bag as claimed in claim 1, wherein said line of weakness is formed as a perforation.

3. A method of forming a bag as claimed in claim 1, wherein said line of weakness is formed as a slit.

4. A method of forming a bag as claimed in any one of claims 1 to 3, wherein there is provided at least one self-closing opening in bag thus formed.

5. A method of forming a bag as claimed in any one of claims 1 to 4, wherein said patch is stitched to the portion of material forming said part of the bag.

6. A method of forming a bag as claimed in any one of claims 1 to 4, wherein said patch is heat sealed to the portion of material forming said part of the bag.

7. A method of forming a bag as claimed in any one of claims 1 to 6, wherein said at least one self-closing opening is formed within or comprises part of a gusset which is also formed during said method.

8. A method of forming a bag as claimed in any one of claims 1 to 7, wherein said method includes a further step which allows for the bag, thus formed, to include carrying means such as a handle.

9. A method of forming a bag as claimed in claim 8, wherein said handle is formed by cutting, and/or punching, and/or heating a section of the bag either during the bag forming step(s), or after the bag has been formed, to form an aperture which may act as the handle.

10. A method of forming a bag as claimed in any one of claims 1 to 9 wherein said method includes a step which allows for the formation of closure means, said closure means being adapted or able to close and/or seal said at least one self-closing opening as or when required or desired.

11. A method of forming a bag as claimed in claim 10, wherein said closure means is formed by attaching a closure flap to the outside of the bag thus formed, and adjacent to the self-closing opening.

12. A method of forming a bag as claimed in claim 11, wherein said closure flap is provided with sealing means to enable it to be sealed over said self-closing opening.

13. A method of forming a bag as claimed in claim 12, wherein said sealing means is adapted, or allows for, the releasable sealing of said closure flap over said self-closing opening.

14. A bag, formed from any of the method as claimed in any one of claims 1 to 13.

15. Bag forming machinery for forming the bag as claimed in any one of claims 1 to 14.

16. A bag with a self-closing opening, said self-closing opening being formed by a line of weakness in the bag, and a patch placed over the line of weakness.

17. A bag as claimed in claim 16, wherein said patch is located substantially inside the bag.

18. A method of forming a bag, substantially as herein described, and with reference to the accompanying drawings.

19. A bag, substantially as herein described, and with reference to the accompanying drawings.
